(19) United States
(12) Patent Application Publication
(10) Pub. No.: US 2007/0047646 A1
(43) Pub. Date: Mar. 1, 2007

(54) Image compression apparatus and method

(75) Inventors: Hyuk-jin Koh, Seoul (KR); Sang-wool Kim, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/510,969

(22) Filed: Aug. 28, 2006

(30) Foreign Application Priority Data
Aug. 26, 2005 (KR) 10-2005-0078907

(51) Int. Cl. H04N 11/04; H04N 7/12

(52) U.S. Cl. 375/240.03; 375/240.12; 375/240.2

(57) ABSTRACT

Provided is an image compression apparatus and method. The image compression apparatus compresses a captured image by performing discrete cosine transformation on image data of the captured image and includes a prediction unit, a quantization unit, and an encoding unit. The prediction unit generates a prediction value for predicting the size of a compressed image with respect to the captured image according to the amount of high-frequency components of a first direction of image data in a previous frame of the captured image and the amount of high-frequency components of a second direction of the image data in the previous frame. The quantization unit selects a predetermined quantization table according to the generated prediction value and quantizes the discrete cosine transformed image data using the selected quantization table. The encoding unit encodes the quantized image data.

### CROSS-REFERENCE TO RELATED PATENT APPLICATION

This application claims priority to Korean Patent Application No. 10-2005-0078907, filed on Aug. 26, 2005, in the Korean Intellectual Property Office, the disclosure of which is incorporated by reference herein in its entirety.

### BACKGROUND OF THE INVENTION

1. Technical Field

The present invention relates to an image compression apparatus and method, and more particularly, to an image compression apparatus and method wherein an image is compressed into a predetermined size by predicting the size of a compressed image and selecting a quantization table.

2. Discussion of the Related Art

When users photograph an image using a digital still camera or a cellular phone camera, they view a moving image displayed on a display device such as a liquid crystal display (LCD) and capture an image to be photographed. The captured image is compressed by a predetermined image compression method and is stored in a file format. There are representative image compression formats such as a graphics interchange format (GIF) and a joint photographic experts group (JPEG) format. Among those formats, the JPEG format compatible with moving picture experts group (MPEG), which has been used as a moving picture standard, is widely used.

FIG. 1 is a block diagram of a conventional image compression apparatus 100. The image compression apparatus 100 uses a JPEG image compression technique and includes a discrete cosine transformation unit 110, a quantization unit 130, and an encoding unit 150.

The discrete cosine transformation unit 110 performs discrete cosine transformation on image data of an image captured by a user and outputs the discrete cosine transformed image data. The quantization unit 130 includes a predetermined quantization table and quantizes the discrete cosine transformed image data according to the quantization table.

The encoding unit 150 includes an encoding table of a predetermined encoding method, encodes the quantized data according to the encoding table, and outputs compressed image data. In the JPEG image compression technique, entropy encoding is used as the encoding method.

The compressed image data output from the encoding unit 150 is stored in a file format, and the size of the compressed image data file (i.e., the size of a compressed image) is generally determined by the complexity of the captured image and a quantization table. However, since the quantization table is predetermined before the image is captured, the size of the compressed image is determined by the complexity of the captured image. In other words, the size of a compressed image increases when a high-complexity image is captured, and the size of a compressed image decreases when a low-complexity image is captured.

Since the size of a memory included in a digital still camera or a cellular phone to store compressed image data is generally limited, the efficient use of the memory is required. However, in a conventional image compression technique, the size of a compressed image changes with the complexity of a captured image, resulting in sub-optimal usage of the memory.

A need therefore exists for an image compression apparatus and method wherein an image is compressed into a predetermined size by predicting the size of a compressed image and selecting a quantization table.

### SUMMARY OF THE INVENTION

According to one aspect of the present invention, there is provided an image compression apparatus. The image compression apparatus compresses a captured image by performing discrete cosine transformation on image data of the captured image and includes a prediction unit, a quantization unit, and an encoding unit. The prediction unit generates a prediction value for predicting the size of a compressed image with respect to the captured image according to the amount of high-frequency components of a first direction of image data in a previous frame of the captured image and the amount of high-frequency components of a second direction of the image data in the previous frame. The quantization unit selects a predetermined quantization table according to the generated prediction value and quantizes the discrete cosine transformed image data using the selected quantization table. The encoding unit encodes the quantized image data.

The prediction unit may include a first high-frequency measurement unit, a second high-frequency measurement unit, and a prediction value generation unit. The first high-frequency measurement unit performs differential pulse code modulation on adjacent pairs of pixels in the first direction in the previous frame and obtains a sum of absolute values of the differential pulse code modulated values, thereby measuring the amount of first high-frequency components. The second high-frequency measurement unit performs differential pulse code modulation on adjacent pairs of pixels in the second direction in the previous frame and obtains a sum of absolute values of the differential pulse code modulated values, thereby measuring the amount of second high-frequency components. The prediction value generation unit generates the prediction value by summing the amount of first high-frequency components and the amount of second high-frequency components.

The differential pulse code modulation may be performed by obtaining differences between the luminance levels of the adjacent pixels.

The first direction may be a horizontal direction and the second direction may be a vertical direction. The first high-frequency measurement unit may measure the amount of high-frequency components in each row of the previous frame by obtaining a sum of absolute values of the differences between the luminance levels of adjacent pixels in each row and sum the amounts of high-frequency components in all rows of the previous frame, thereby measuring the amount of first high-frequency components. The second high-frequency measurement unit may measure the amount of high-frequency components in each column of the previous frame by obtaining a sum of absolute values of the differences between the luminance levels of adjacent pixels in each column and sum the amounts of high-frequency components in all columns of the previous frame, thereby measuring the amount of second high-frequency components.

The compressed image may be in a JPEG (joint photographic experts group) format.

According to another aspect of the present invention, there is provided an image compression method, in which a captured image is compressed by performing discrete cosine transformation on image data of the captured image. The image compression method includes generating a prediction value for predicting the size of a compressed image with respect to the captured image according to the amount of high-frequency components of a first direction of image data in a previous frame of the captured image and the amount of high-frequency components of a second direction of the image data in the previous frame, selecting a predetermined quantization table according to the generated prediction value and quantizing the discrete cosine transformed image data using the selected quantization table, and encoding the quantized image data.

According to still another aspect of the present invention, there is provided an apparatus for predicting the size of a compressed image with respect to a captured image. The apparatus includes a first high-frequency measurement unit, a second high-frequency measurement unit, and a prediction value generation unit. The first high-frequency measurement unit performs differential pulse code modulation on adjacent pairs of pixels in a first direction in a previous frame of the captured image and obtains a sum of absolute values of the differential pulse code modulated values, thereby measuring the amount of first high-frequency components. The second high-frequency measurement unit performs differential pulse code modulation on all pairs of pixels adjacent in a second direction in the previous frame and obtains a sum of absolute values of the differential pulse code modulated values, thereby measuring the amount of second high-frequency components. The prediction value generation unit generates the prediction value by summing the amount of first high-frequency components and the amount of second high-frequency components.

According to yet another aspect of the present invention, there is provided a method of predicting the size of a compressed image with respect to a captured image. The method includes performing differential pulse code modulation on adjacent pairs of pixels in a first direction in a previous frame of the captured image and obtaining a sum of absolute values of the differential pulse code modulated values, thereby measuring the amount of first high-frequency components, performing differential pulse code modulation on adjacent pairs of pixels in a second direction in the previous frame and obtaining a sum of absolute values of the differential pulse code modulated values, thereby measuring the amount of second high-frequency components, and generating a prediction value by summing the amount of first high-frequency components and the amount of second high-frequency components.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a conventional image compression apparatus;

FIG. 2 is a block diagram of an image compression apparatus according to an embodiment of the present invention;

FIG. 3 is a block diagram of a prediction unit of FIG. 2;

FIG. 4 is a view showing size prediction of a compressed image;

FIG. 5 illustrates quantization tables selected according to prediction values;

FIG. 6 is a graph showing the relationship between a prediction value and the actual size of a compressed image; and

FIG. 7 is a graph showing the comparison between the sizes of a predetermined number of compressed images.

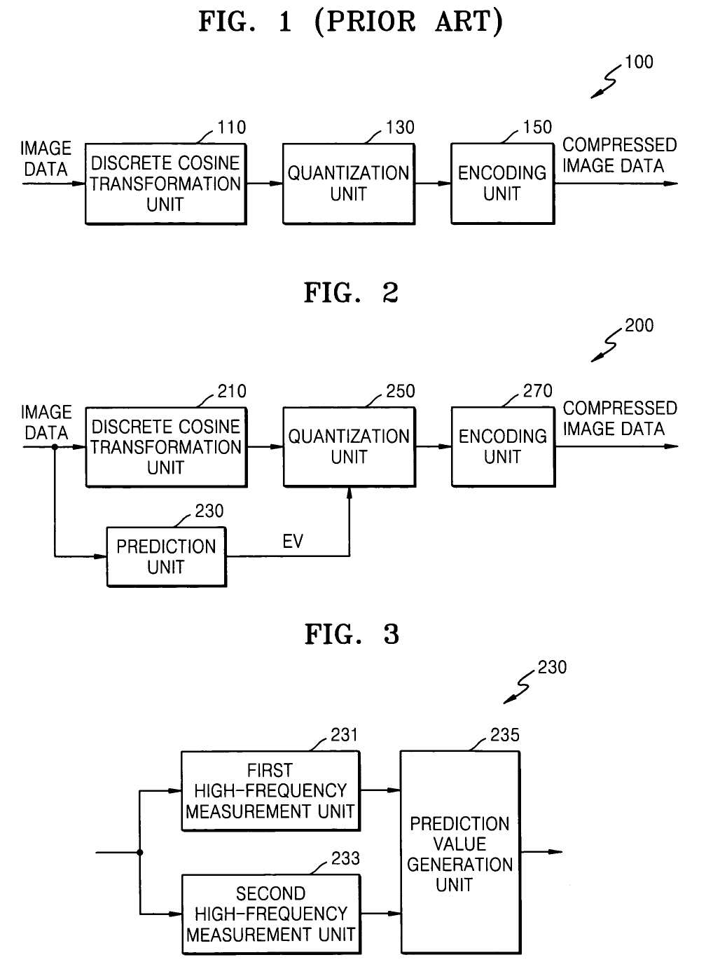

### DETAILED DESCRIPTION OF PREFERRED EMBODIMENTS

Preferred embodiments of the present invention will now be described more fully with reference to the accompanying drawings. In the drawings, the same or similar elements are denoted by the same reference numerals.

It has been found that the complexity of an image is substantially proportional to the occurrence of high-frequency components in the image. The high-frequency components of the image increase when a change between adjacent pixels is large. In particular, as the high-frequency components increase, a change between the luminance levels of adjacent pixels also increases. As the complexity of an image increases because the image contains a large amount of high-frequency components, the size of the compressed image also increases.

The human eyes are sensitive to low-frequency components, but are relatively insensitive to high-frequency components. Thus, in image compression, it is necessary to compress an image having a high occurrence of high-frequency components after quantizing the image using a large step size, and compress an image having a low occurrence of high-frequency components after quantizing the image using a small step size.

In at least one embodiment of the present invention, the amount of high-frequency components in a previous moving picture frame having high correlation with a captured image is measured to obtain a prediction value for predicting the size of a compressed image, and a quantization table for quantizing the captured image is selected according to the obtained prediction value, thereby maintaining the size of the compressed image constant.

FIG. 2 is a block diagram of an image compression apparatus 200 according to an embodiment of the present invention. The image compression apparatus 200 performs JPEG compression including discrete cosine transformation on image data of a captured image.

The image compression apparatus 200 includes a discrete cosine transformation unit 210, a prediction unit 230, a quantization unit 250, and an encoding unit 270. The discrete cosine transformation unit 210 performs discrete cosine transformation on the image data of the captured image.

The prediction unit 230 generates a prediction value EV according to the amount of first-direction high-frequency components and the amount of second-direction high-frequency components of image data of a previous frame of the captured image and predicts the size of a compressed image with respect to the captured image according to the prediction value EV.

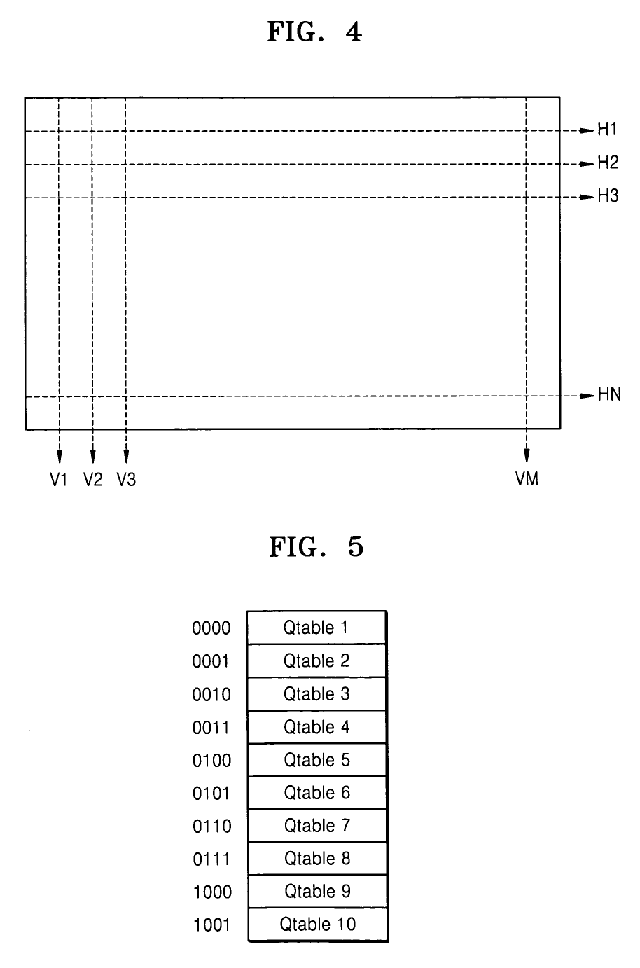

For example, the prediction unit 230 generates the prediction value EV using high-frequency components of a previous frame and predicts the size of a compressed image into which the captured image is compressed using the prediction value EV. Hereinafter, the configuration and operation of the prediction unit 230 will be described with reference to FIGS. 3 and 4.

FIG. 3 is a block diagram of the prediction unit 230 of FIG. 2.

The prediction unit 230 includes a first high-frequency measurement unit 231, a second high-frequency measurement unit 233, and a prediction value generation unit 235. The first high-frequency measurement unit 231 performs differential pulse code modulation (DPCM) on all pairs of pixels adjacent in a first direction in a previous frame and obtains a sum of absolute values of the differential pulse code modulated values, thereby measuring the amount of first high-frequency components.

The second high-frequency measurement unit 233 performs DPCM on all pairs of pixels adjacent in a second direction in the previous frame and obtains a sum of absolute values of the differential pulse code modulated values, thereby measuring the amount of second high-frequency components.

The prediction value generation unit 235 generates the prediction value EV by adding the amount of first high-frequency components and the amount of second high-frequency components.

In an embodiment of the present invention, the first direction and the second direction may be a vertical direction and a horizontal direction, respectively, and the prediction unit 230 may perform DPCM using the luminance levels of pixels.

Hereinafter, an operation of the prediction unit 230 to obtain the prediction value EV by measuring the amount of vertical high-frequency components and the amount of horizontal high-frequency components using the luminance levels of pixels will be described in detail with reference to FIGS. 3 and 4.

FIG. 4 is a view for explaining prediction of the size of a compressed image.

The first high-frequency measurement unit 231 measures the amount of high-frequency components of each row and sums the amounts of high-frequency components of all rows, thereby measuring the amount of horizontal high-frequency components.

High-frequency components represent the complexity of a captured image and can be obtained using a difference between adjacent pixels. In an embodiment of the present invention, the amount of high-frequency components is measured by obtaining a sum of absolute values of differences between the luminance levels of adjacent pixels using DPCM.

For example, when the luminance levels of pixels in the first row are . . . , 89, 93, 135, 132, 145, . . . , the differential pulse code modulated values of pairs of adjacent pixels are . . . , (93−89), (135−93), (132−135), (145−132), . . . . As mentioned above, in an embodiment of the present invention, a sum of absolute values of the differential pulse code modulated values is used as the amount of high-frequency components, and thus the amount H1 of high-frequency components in the first row is as follows.
H1= . . . +|89−93|+|135−93|+|132−135|+|145−132|+ . . .

Similarly, the amounts H2, H3, . . . , HN of high-frequency components in N rows of a previous frame can be measured and the amount HSUM of horizontal high-frequency components can be measured by summing the amounts of high-frequency components in the N rows as follows.
HSUM=H1+H2+ . . . +HN

The second high-frequency measurement unit 233 obtains the amount of high-frequency components in each column and sums the amounts of high-frequency components of all columns, thereby measuring the amount of vertical high-frequency components.

The amounts V1, V2, . . . VM of high-frequency components in the columns can be obtained in the same manner as the amounts of high-frequency components in the rows, obtained by the first high-frequency measurement unit 231. The second high-frequency measurement unit 233 can measure the amount VSUM of vertical high-frequency components by summing the amounts of high-frequency components in M columns as follows.
VSUM=V1+V2+ . . . +VN

The prediction value generation unit 250 generates the prediction value EV by summing the amount HSUM of horizontal high-frequency components and the amount VSUM of vertical high-frequency components as follows.
EV=HSUM+VSUM

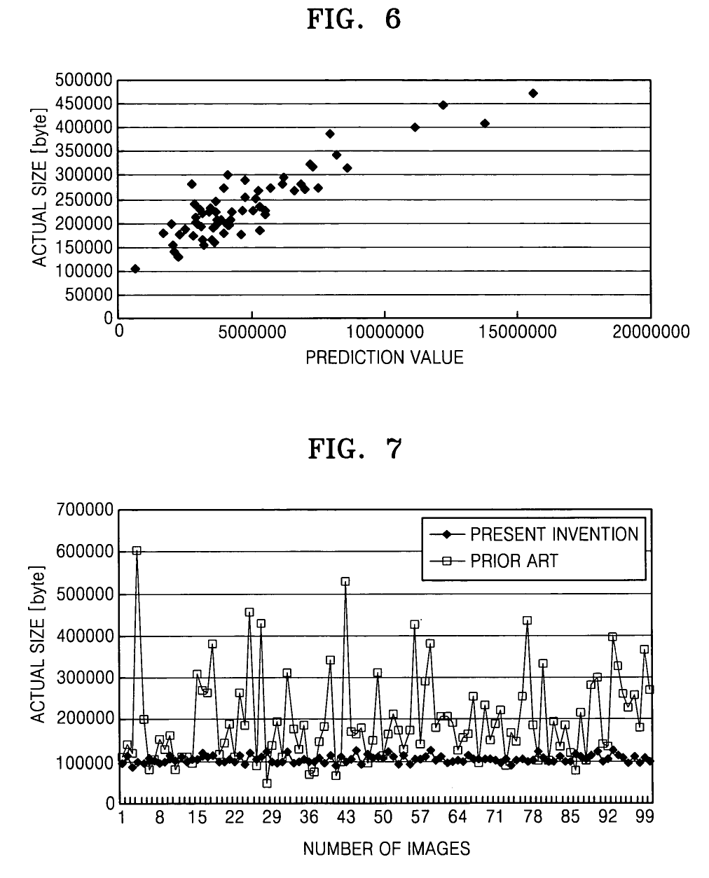

FIG. 6 is a graph showing the relationship between the prediction value EV and the actual size of a compressed image. In FIG. 6, 66 VGA images are used. The horizontal axis indicates the prediction value EV obtained by the prediction unit 230 and the vertical axis indicates the actual size of a compressed image.

As illustrated in FIG. 6, since the prediction value EV and the actual size of a compressed image are proportional to each other, there is a high level of correlation. In other words, the size of a compressed image can be predicted based on the obtained prediction value EV. As a result of measuring the correlation, such as by using a Minitab tool, the prediction value EV and the actual size of a compressed image have a high correlation of 0.894.

The quantization unit 250 selects a predetermined quantization table according to the prediction value EV generated by the prediction unit 230 and quantizes discrete cosine transformed image data using the selected quantization table. Hereinafter, an operation of the quantization unit 250 will be described in detail with reference to FIG. 5.

FIG. 5 illustrates quantization tables selected according to prediction values.

As illustrated in FIG. 5, a total of 10 quantization tables are provided in an embodiment of the present invention. Quantization is performed using a large step size in a direction from top to bottom of the quantization tables. The quantization tables illustrated in FIG. 5 may be included in the quantization unit 250 or may be separately stored outside of the quantization unit 250.

In an embodiment of the present invention, the quantization unit 250 selects a quantization table using 4 most significant bits (MSB) of the prediction value EV. As the prediction value EV increases, the size of a compressed image also increases. As the prediction value EV decreases, the size of a compressed image decreases.

Thus, as the prediction value EV increases, i.e., the MSB increases, the quantization unit 250 selects a quantization table (i.e., a lower-position quantization table among the quantization tables of FIG. 5) according to which quantization is performed using a large step size to cause compression to be performed using a large quantization step size. As the prediction value EV decreases, i.e., the MSB decreases, the quantization unit 250 selects a quantization table (i.e., an upper-position quantization table among the quantization tables of FIG. 5) according to which quantization is performed using a small step size to cause compression to be performed using a small quantization step size.

For example, when the MSBs of the prediction value EV are 0000, the quantization unit 250 selects a quantization table Qtable 1 according to which quantization is performed using the smallest step size and quantizes the discrete cosine transformed image data. When the MSB of the prediction value EV are 1001, the quantization unit 250 selects a quantization table Qtable 10 according to which quantization is performed using the largest step size and quantizes the discrete cosine transformed image data.

It can be seen that when the size of a file is predicted to be large; quantization is performed using a large step size for more compression. When the size of a file is predicted to be small, quantization is performed using a small step size for less compression. In this way, the size of a compressed image can be maintained constant regardless of the complexity of a captured image.

The encoding unit 270 encodes the image data quantized by the quantization unit 250 and outputs compressed image data. Thus, compression of the captured image is completed.

FIG. 7 is a graph showing the comparison between the sizes of a predetermined number of compressed images.

In FIG. 7, the sizes of compressed images with respect to 100 VGA images are shown, and a square indicates the size of a compressed image according to conventional art and a diamond indicates the size of a compressed image according to an embodiment of the present invention.

As illustrated in FIG. 7, when images are compressed according to conventional art, the sizes of compressed images vary. On the other hand, when images are compressed according to an embodiment of the present invention, the sizes of compressed images are constant.

By maintaining the size of a compressed image file constant, the use of the memory storing the compressed image file can be more efficient.

Moreover, by performing quantization on an image having a high occurrence of high-frequency components to which the human eyes are insensitive using a large step size, the size of a compressed image file is maintained constant, thereby efficiently performing compression.

While the present invention has been particularly shown and described with reference to an exemplary embodiments thereof, it will be understood by those of ordinary skill in the art that various changes in form and details may be made therein without departing from the spirit and scope of the present invention as defined by the following claims.

What is claimed is:

1. An image compression apparatus which compresses a captured image as image data, the image compression apparatus comprising:
a prediction unit generating a prediction value for predicting the size of a compressed image with respect to the captured image according to the amount of high-frequency components of a first direction of image data in a previous frame of the captured image and the amount of high-frequency components of a second direction of the image data in the previous frame;
a quantization unit selecting a predetermined quantization table according to the generated prediction value and quantizing the discrete cosine transformed image data using the selected quantization table; and
an encoding unit encoding the quantized image data.

2. The image compression apparatus of claim 1, wherein the prediction unit comprises:
a first high-frequency measurement unit performing differential pulse code modulation on adjacent pairs of pixels in the first direction in the previous frame and obtaining a sum of absolute values of the differential pulse code modulated values, thereby measuring the amount of first high-frequency components;
a second high-frequency measurement unit performing differential pulse code modulation on adjacent pairs of pixels in the second direction in the previous frame and obtaining a sum of absolute values of the differential pulse code modulated values, thereby measuring the amount of second high-frequency components; and
a prediction value generation unit generating the prediction value by summing the amount of first high-frequency components and the amount of second high-frequency components.

3. The image compression apparatus of claim 2, wherein the differential pulse code modulation is performed by obtaining differences between the luminance levels of the adjacent pixels.

4. The image compression apparatus of claim 2, wherein the first direction is a horizontal direction and the second direction is a vertical direction,
the first high-frequency measurement unit measures the amount of high-frequency components in each row of the previous frame by obtaining a sum of absolute values of the differences between the luminance levels of adjacent pixels in each row and sums the amounts of high-frequency components in all rows of the previous frame, thereby measuring the amount of first high-frequency components, and
the second high-frequency measurement unit measures the amount of high-frequency components in each column of the previous frame by obtaining a sum of absolute values of the differences between the luminance levels of adjacent pixels in each column and sums the amounts of high-frequency components in all columns of the previous frame, thereby measuring the amount of second high-frequency components.

5. The image compression apparatus of claim 1, wherein the compressed image is in a JPEG (joint photographic experts group) format.

6. The image compression apparatus of claim 1, further including a discrete cosine transformer for transforming the captured image as part of the compression process.

7. A method of compressing a captured image represented by image data, comprising:
performing discrete cosine transform on the captured image;
generating a prediction value for predicting the size of a compressed image with respect to the captured image according to the amount of high-frequency components of a first direction of image data in a previous frame of the captured image and the amount of high-frequency components of a second direction of the image data in the previous frame;
selecting a predetermined quantization table according to the generated prediction value and quantizing the discrete cosine transformed image data using the selected quantization table; and
encoding the quantized image data.

8. The method of claim 7, wherein the generation of the prediction value comprises:
performing differential pulse code modulation on adjacent pairs of pixels in the first direction in the previous frame and obtaining a sum of absolute values of the differential pulse code modulated values, thereby measuring the amount of first high-frequency components;
performing differential pulse code modulation on adjacent pairs of pixels in the second direction in the previous frame and obtaining a sum of absolute values of the differential pulse code modulated values, thereby measuring the amount of second high-frequency components; and
generating the prediction value by summing the amount of first high-frequency components and the amount of second high-frequency components.

9. The method of claim 8, wherein the differential pulse code modulation is performed by obtaining differences between the luminance levels of the adjacent pixels.

10. The method of claim 8, wherein the first direction is a horizontal direction and the second direction is a vertical direction,
the amount of high-frequency components in each row of the previous frame is measured by obtaining a sum of absolute values of the differences between the luminance levels of adjacent pixels in each row and the amounts of high-frequency components in all rows of the previous frame are summed, thereby measuring the amount of first high-frequency components, and
the amount of high-frequency components in each column of the previous frame is measured by obtaining a sum of absolute values of the differences between the luminance levels of adjacent pixels in each column and the amounts of high-frequency components in all columns of the previous frame are summed, thereby measuring the amount of second high-frequency components.

11. The method of claim 7, wherein the compressed image is in a JPEG (joint photographic experts group) format.

12. An apparatus for predicting the size of a compressed image with respect to a captured image, the apparatus comprising:
a first high-frequency measurement unit performing differential pulse code modulation on adjacent pixels in a first direction in a previous frame of the captured image and obtaining a sum of absolute values of the differential pulse code modulated values, thereby measuring the amount of first high-frequency components;
a second high-frequency measurement unit performing differential pulse code modulation on adjacent pixels in a second direction in the previous frame and obtaining a sum of absolute values of the differential pulse code modulated values, thereby measuring the amount of second high-frequency components; and
a prediction value generation unit generating a prediction value by summing the amount of first high-frequency components and the amount of second high-frequency components.

13. A method of predicting the size of a compressed image with respect to a captured image, the method comprising:
performing differential pulse code modulation on adjacent pixels in a first direction in a previous frame of the captured image and obtaining a sum of absolute values of the differential pulse code modulated values, thereby measuring the amount of first high-frequency components;
performing differential pulse code modulation on adjacent pixels in a second direction in the previous frame and obtaining a sum of absolute values of the differential pulse code modulated values, thereby measuring the amount of second high-frequency components; and
generating a prediction value by summing the amount of first high-frequency components and the amount of second high-frequency components.
